(19) United States
(12) Patent Application Publication
(10) Pub. No.: US 2020/0400247 A1
(43) Pub. Date: Dec. 24, 2020

(54) COMPRESSED GAS TANK LOCKING DEVICE

(71) Applicant: Sam Travis Decker, Spring Park, MN (US)

(72) Inventor: Sam Travis Decker, Spring Park, MN (US)

(21) Appl. No.: 16/446,453

(22) Filed: Jun. 19, 2019

(51) Int. Cl. F16K 35/06; E05B 67/38; F17C 13/06

(52) U.S. Cl. CPC F16K 35/06; E05B 67/383; F17C 2205/0311; F17C 2201/0104; F17C 13/06

(57) ABSTRACT

The disclosure includes a compressed gas tank locking device that can include an elongate housing. The elongate housing may include a closed end and an open end located opposite the closed end. The elongate housing may further include a sidewall extending between the closed end and the open end, a first aperture extending through the sidewall, and a second aperture extending through the sidewall. The second aperture may be located opposite the first aperture.

### BACKGROUND

### Field

Various embodiments disclosed herein relate to locking devices. Certain embodiments relate to locking devices for compressed gas tanks.

### Description of Related Art

Compressed gas tanks (also referred to as “gas cylinders”) store compressed gases under high pressure to allow controlled use of the stored gas or gases. Compressed gas tanks are widely used across many industries, including the medical, engineering, industrial, chemical, and biotechnology industries, among others. Gas cylinders can house a variety of gases, including nitrogen, oxygen, carbon dioxide, argon, hydrogen, helium, and so on, which are utilized through a valve situated on top of the gas cylinder. Because the gases within the tank are stored under significant pressure, there are many potential hazards associated with the presence of gas cylinders.

A number of potential hazards are related directly to use and care of the compressed gas tank's valve. Valves must be fully closed when not in use to prevent such hazards, which include corrosion of the gas tank, contamination of the stored gas, rapid release of the stored gas, fires, and explosions, among others. To prevent such incidents, many handling and storing safety measures are taken by those who work with compressed gas tanks. For example, it is common practice for the valve of a gas tank to remain closed at all times when said gas tank is not being utilized. However, the risk of a valve being knocked loose during the transportation and storage of gas cylinders still exists, despite such recommended handling and storage techniques.

Additionally, compressed gas tanks may be stored in areas which people not qualified to use the tanks may have access. For example, many senior citizens use oxygen tanks for assisted breathing. Accordingly, young grandchildren may thus have inadvertent access to the oxygen tanks. In another example, industrial manufacturers that use gas cylinders for a variety of tasks may employ people not qualified nor trained for using such gas cylinders. To someone who simply needs to move a gas cylinder out of the way during work, qualification or training for handling and storing gas tanks may not seem to necessary. However, improperly moving or storing a compressed gas tank can have disastrous results, such as gas leaks and explosions.

Despite safety procedures employed by businesses and individuals in possession of compressed gas tanks, vandals may gain illegal access to a facility containing compressed gas tanks by, for example, breaking in to such a facility. The damage such an intruder can cause by tampering with compressed gas cylinders and the respective valves can be costly and threatening to both the facility itself and the lives of people in the facility. Unauthorized access to compressed gas tanks, such as e cylinders, may also occur at hospitals and gas stations, among others. Although gas cylinders are typically kept in areas with restricted access, in the event that someone gains access to the cylinder and an incident (e.g., an explosion) occurs, the entity owning the gas cylinder may be liable for damage caused to people and property, even though the entity was not the cause of the incident. Even a small adjustment to the valve that may seem harmless can result in disaster.

Furthermore, e cylinder compressed gas tanks may be easily transported due to their size; as such, a single person may be able to easily steal such tanks. Theft of e cylinder compressed gas tanks has increased significantly over the past few years. Although owners' names of e cylinder compressed gas tanks are typically included on the bodies of the tanks, there are many circumstances under which the rightful owner's name does not correspond to the name on the tank. For example, companies going out of business or selling off unneeded inventory may sell their e cylinder compressed gas tanks. Such tanks may include the name of the selling company on the body of the tanks, but the name of the new owner may not always be listed on the tank. This confusion is quite common so verifying ownership of a gas cylinder is not widely enforced. As such, someone in possession of a stolen gas cylinder may refill the cylinder with ease at a number of large retailers. As e cylinder compressed gas tanks contain controlled substances, distributing such substances to unauthorized or unlicensed individuals can result in liability for the retailer and the company whose name appears on the gas cylinder, neither of which were aware of the stolen item.

Furthermore, theft of gas cylinder is largely related to the material from which the cylinder is formed. A majority of e cylinder compressed gas tanks are made from aluminum. Typical e cylinders have retail values in the hundreds of dollars. Thieves steal the cylinders to sell for cash, often at recycling facilities where no ownership verification is required. For example, stealing an oxygen tank from a senior citizen may be as easy as carrying the tank off the owner's property. Thieves then release the oxygen from the tank using the valve and can sell said tank.

The consequences of mishandling gas cylinders are great and can include serious damage and injury to people, property, and entity reputation. Furthermore, theft of gas cylinders has increased steadily in recent years, as proof of cylinder ownership becomes harder to verify. Thus, there is a need for a device that can prevent both tampering with and inadvertent adjustments to a compressed gas tank's valve, as well as deter thieves.

### SUMMARY

The disclosure describes a compressed gas tank locking device. The compressed gas tank locking device may comprise an elongate housing. The elongate housing may include a closed end and an open end located opposite the closed end. The elongate housing may further include a sidewall extending between the closed end and the open end, a first aperture extending through the sidewall, and a second aperture extending through the sidewall. The second aperture may be located opposite the first aperture.

In some embodiments, the elongate housing may be sized and configured to slidably and snuggably engage a top portion of an ecylinder compressed gas tank. The first aperture and the second aperture may be sized and configured to slidably receive a locking device. The first aperture and the second aperture may further be arranged and configured such that when the first aperture and the second aperture receive the locking device, the elongate housing may snuggably engage with the top portion of the ecylinder compressed gas tank.

In several embodiments, the sidewall comprises a first sidewall, a second sidewall located opposite the first sidewall, a third sidewall located between the first sidewall and the second sidewall, and a fourth sidewall located opposite the third sidewall. As well, the closed end and the open end of the elongate housing may each define a rectangular shape. In some embodiments, the sidewall of the elongate housing may define at least one sidewall such that the closed end and the open end may define at least one of a circular, triangular, rectangular, pentagonal, hexagonal, and the like shape.

In some embodiments, the first aperture extends through the first sidewall, and the second aperture extends through the second sidewall. The first aperture may be located closer to the open end than the closed end. As well, the second aperture may be located closer to the open end than the closed end. Furthermore, the first aperture may be located closer to the third sidewall than the fourth sidewall, and the second aperture may be located closer to the third sidewall than the fourth sidewall.

In some embodiments, the first aperture is located about 0.125 inches from the open end and the second aperture is located about 0.125 inches from the open end. The first aperture may be located about 0.125 inches from the third sidewall. As well, the second aperture may be located within 0.125 inches from the third sidewall. Further, the first aperture and the second aperture may each define a diameter of about 0.25 inches. It should be appreciated that the locations of the first aperture and the second aperture relative to the sidewall and/or sidewalls of the elongate housing may vary. It should also be appreciated that the diameters of the first aperture and the second aperture may vary in size.

In several embodiments, the first sidewall, second sidewall, third sidewall, and fourth sidewall each define a height that is less than or equal to about 4 inches. Additionally, the first sidewall, second sidewall, third sidewall, and fourth sidewall may each define a width that is less than or equal to about 2 inches.

In some embodiments, the first sidewall, second sidewall, third sidewall, and fourth sidewall each define a height equal to about 3.5 inches. The first sidewall, second sidewall, third sidewall, and fourth sidewall may each define a width equal to about 1.5 inches.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates an environmental, perspective view of a compressed gas tank locking device, according to some embodiments.

FIG. 2 illustrates a perspective view of a compressed gas tank locking device, according to some embodiments.

FIG. 3 illustrates a perspective view of a compressed gas tank locking device, according to some embodiments.

FIGS. 4A-4C illustrate perspective views of a compressed gas tank locking device, according to some embodiments.

FIG. 5 illustrates a perspective bottom view of a compressed gas tank locking device, according to some embodiments.

FIG. 6A illustrates a first side of a compressed gas tank locking device, according to some embodiments.

FIG. 6B illustrates a second side of a compressed gas tank locking device, according to some embodiments.

FIG. 6C illustrates a third side of a compressed gas tank locking device, according to some embodiments.

FIG. 6D illustrates a fourth side of a compressed gas tank locking device, according to some embodiments.

FIG. 7 illustrates a device sized and configured to couple to an e cylinder, according to a specific embodiment.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### REFERENCE NUMERALS

10—Compressed gas tank locking device
12—E cylinder compressed gas tank
14—Locking device
16—Elongate housing
18—Closed end
20—Open end
22—Sidewall
24—First aperture
26—Second aperture
28—Hollow interior
30—First sidewall
32—Second sidewall
34—Third sidewall
36—Fourth sidewall
40—Valve
42—Rupture disk
50—Width
54—Height

Compressed gas tanks, often referred to as gas cylinders, house compressed gases under high pressure to allow controlled use of the compressed gases. Gas in a compressed gas tank may be released by a user by the user employing a valve located on a top portion of the compressed gas tank. While many safety procedures are in place to prevent hazards that may occur from misusing a compressed gas cylinder, compressed gas cylinders are still quite dangerous to handle given the nature of the contents. Gas cylinders are thus susceptible to a variety of hazards that may occur due to incorrect, unauthorized, or illegal use. Such hazards may include corrosion of the gas tank, contamination of the stored gas, leakage of the stored gas, and rapid release of the stored gas, among others. These hazards may result in disastrous consequences, such as exposure to toxicity, fires, and explosions.

A gas cylinder valve's position may be changed, for example, during transport of the gas cylinder. Even a small change in the position of the gas cylinder valve may unlock the valve, and the result in one of the aforementioned disasters. Personnel moving gas cylinders, whether such moving involves transporting the cylinder, moving the cylinder from a place of use to a place of storage, or stealing the cylinder, may not realize the consequences of even a slight change to the cylinder's valve. Such personnel may thus not be attentive to the valve's position and ensure that the valve stays in a locked position.

A gas cylinder's valve is also susceptible to tampering, as gas cylinders are constructed such that the valve may be easily accessed. Gas cylinders are often constructed with caps, but such caps are not locked or securely fastened to the cylinder, as they are typically in place to protect the valve during initial transportation from cylinder manufacturers to cylinder customers. Because gas cylinders are typically intended for use in industries, such as medical, welding, and engineering industries, easy and quick access to the valve is provided in the structure of the gas cylinder. Despite safety measures and protocols, untrained personnel may still have access to gas cylinders.

Gas cylinders are also employed for personal use, such as an oxygen tank used for assisted breathing. As gas cylinders contain controlled substances (compressed gas) and are typically constructed from aluminum, an expensive metal, they are highly susceptible to theft. Thieves may steal gas cylinders from individuals using oxygen tanks to sell the aluminum body of the tank for cash. This is not only illegal, but also extremely dangerous as compressed oxygen can react rapidly and violently with combustible materials. As well, thieves may be compelled to steal gas cylinders for the compressed gas contained, such as nitrous oxide (more commonly known as laughing gas). Aluminum is a lightweight metal, so thieves may simply carry a gas cylinder and later release the compressed gas (for use or to ready the cylinder to sell for scrap metal) without difficulty by the employing the easily accessible valve.

As such, this disclosure intends to provide devices to ensure that the gas cylinder valve is not vulnerable to untrained personnel and accidental movements during transport and storage. As well, such devices may deter the theft of e cylinders gas tanks by removing a thief's ability to access the valve. Such devices may comprise a compressed gas tank locking device including an elongate housing. The elongate housing may include a closed end, an open end, and a sidewall extending between the closed and the open end. The compressed gas tank locking device may further include a first aperture extending through the sidewall, and a second aperture extending through the sidewall located opposite the first aperture. The elongate housing may be sized and configured to slidably and snuggably engage a top portion of an e cylinder compressed gas tank. The first aperture and the second aperture may be sized and configured to slidably receive a locking device, such that the elongate housing snuggably engages the compressed gas tank when the first and second apertures receive the locking device. It should be appreciated that the elongate housing of the compressed gas tank locking device may be sized and configured to slidably and snuggably engage a top portion of any compressed gas tank, such as a g cylinder gas tank, an h cylinder gas tank, and the like.

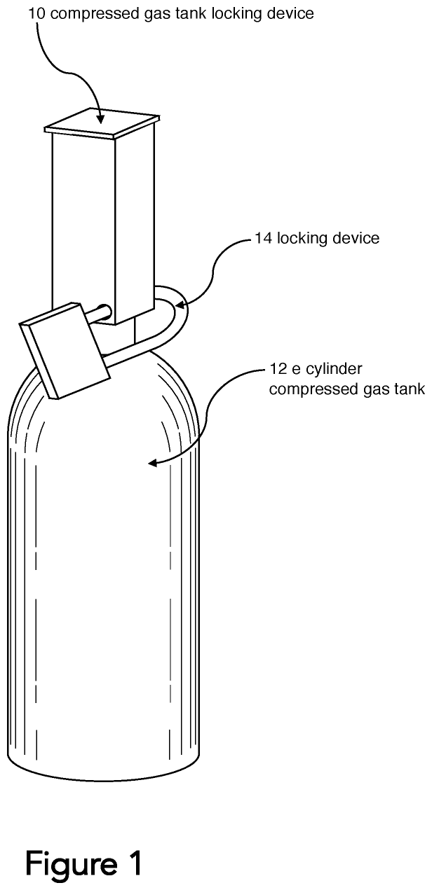

Referring now to FIG. 1, a compressed gas tank locking device 10 (herein after referred to as “device 10”) may be coupled to an e cylinder compressed gas tank 12. The device 10 may be slidably coupled to the e cylinder gas tank 12 such that the device 10 may be mounted on a top portion of the e cylinder compressed gas tank 12. The e cylinder compressed gas tank 12 may comprise a valve located on a top portion thereof. The device 10 may be sized and configured to house the valve of the e cylinder compressed gas tank 12. In several embodiments, the device 10 may be arranged and configured to accept a locking device 14. The locking device 14 may securely engage the device 10 with the e cylinder compressed gas tank 12. The device 10 may thus protect and prevent access to the valve of the e cylinder compressed gas tank 12.

Gas cylinders, such as e cylinder compressed gas tank 12, are typically constructed of aluminum, a lightweight metal, and contain compressed gas (i.e., gas at a pressure higher than atmospheric pressure). Gas cylinders may be susceptible to many risks, including physical danger and thievery. Physical dangers may be caused by inadvertent and even deliberate tampering with the valve. For example, when gas cylinders are knocked over the valve may break, causing the compressed gas contained within to escape rapidly. The compressed gas contained within the cylinder stores enough energy to launch the lightweight cylinder with great thrust if rapidly released and may cause a “rocketing” effect. Although aluminum is lightweight, it is an extremely strong metal and because of this a gas cylinder “rocketing” can cause considerable damage to surrounding structures and people. The device 10 may protect the valve from impact, thus substantially reducing the risk of rapid release of the stored compressed gas.

In some embodiments, it may be preferable that the device 10 comprises a strong and durable material, such that the device 10 may protect the valve of a compressed gas tank from tampering and impact of any kind. Tampering may occur if someone gains unauthorized or illegal access to the compressed gas tank, such as a child or a vandal. For example, a child whose grandparent uses an oxygen gas tank for assisted breathing may find extra gas tanks in their grandparent's residence. Children are characteristically curious by nature, so a child that finds a compressed gas tank may be inquisitive about said gas tank and feel compelled to play or fidget with the tank and valve thereof. Compressed oxygen is highly flammable and explosive, and such fidgeting can result in catastrophe.

In another example, many gas stations have compressed oxygen cylinders used for filling a vehicle's tire with air and compressed natural gas cylinders. Once illegal access is obtained to the compressed gas tank, the criminal or vandal may tamper with a valve of a compressed gas cylinder. Gas stations are full of flammable natural gas and fire or explosion may occur if pressurized oxygen is released into the environment. As well, the results of tampering with compressed natural gas cylinders can be disastrous, including toxic gas leaks, fires, and explosions, among others. The manner in which the device 10 snuggably engages with a compressed gas tank and the durable material of the device 10 may thus inhibit unauthorized use of the valve of the gas tank.

In some embodiments, the device 10 may also preferably comprise a lightweight material, as to minimize the excess weight being imposed upon a compressed gas cylinder. Impact or pressure applied upon the compressed gas cylinder can weaken the material of the cylinder. As the gas or gases contained inside the compressed gas cylinder are stored at a pressure higher than atmospheric pressure, the pressure of the contained gas upon weakened material of the cylinder may cause weakened cylinder to rupture. This may result in toxicity, fires, explosions, and even the compressed gas cylinder “rocketing” as discussed earlier herein. In several embodiments, such a lightweight and durable material may define aluminum. The device 10 may comprise at least one of aluminum, steel, stainless steel, magnesium, titanium, carbon fiber, plastic, alloys, composite materials, any combination thereof, and the like.

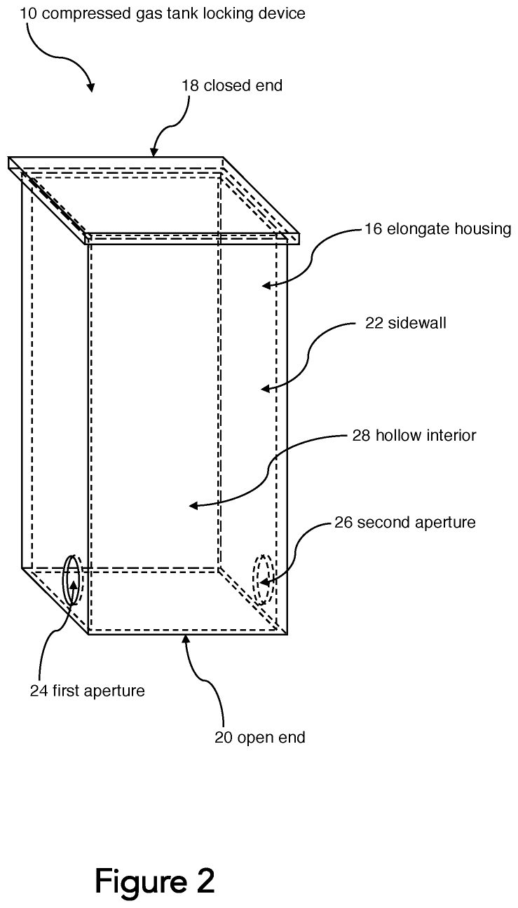

As illustrated in FIG. 2, the compressed gas tank locking device 12 may comprise an elongate housing 16. The elongate housing 16 may include a closed end 18, an open end 20 located opposite the closed end 18, and a sidewall 22 extending between the closed end 18 and the open end 20. The elongate housing 16 may further include a first aperture 24 extending through the sidewall 22 and a second aperture 26 extending through the sidewall 22. The second aperture 26 may be located opposite the first aperture 24.

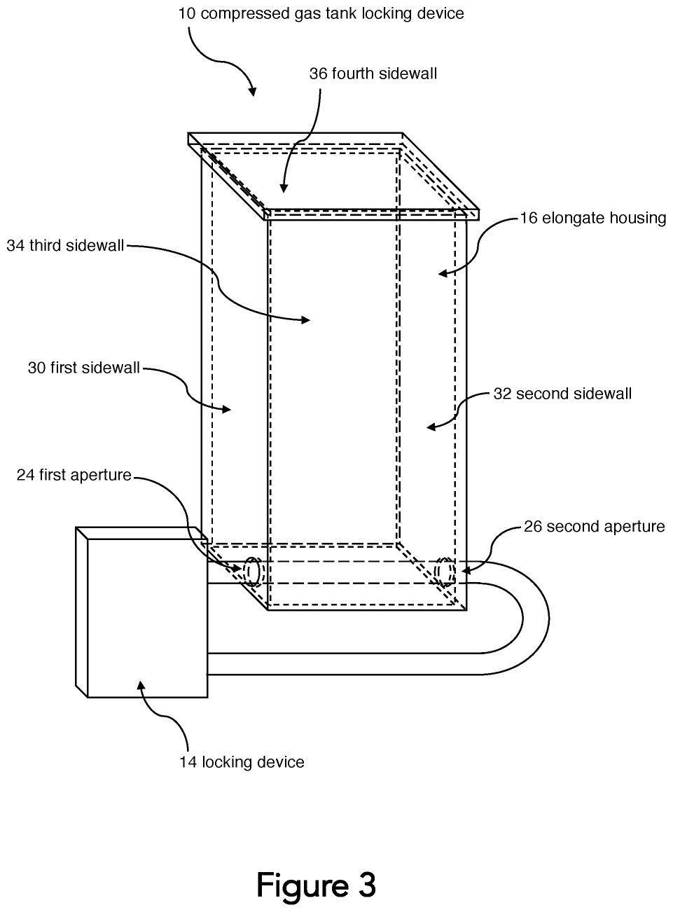

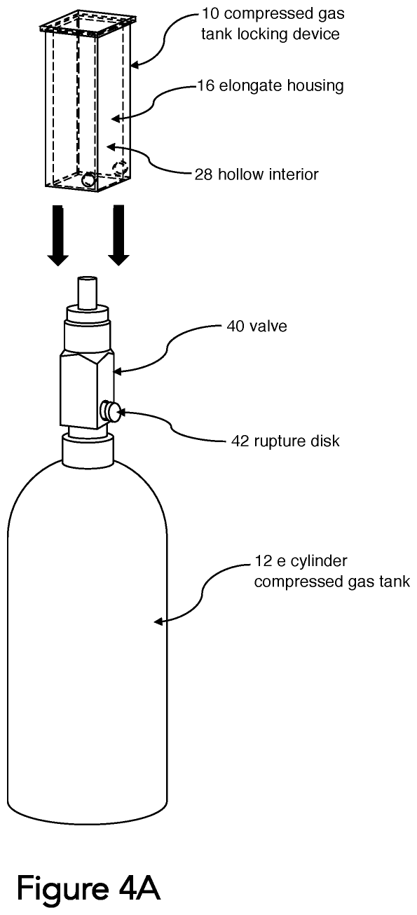

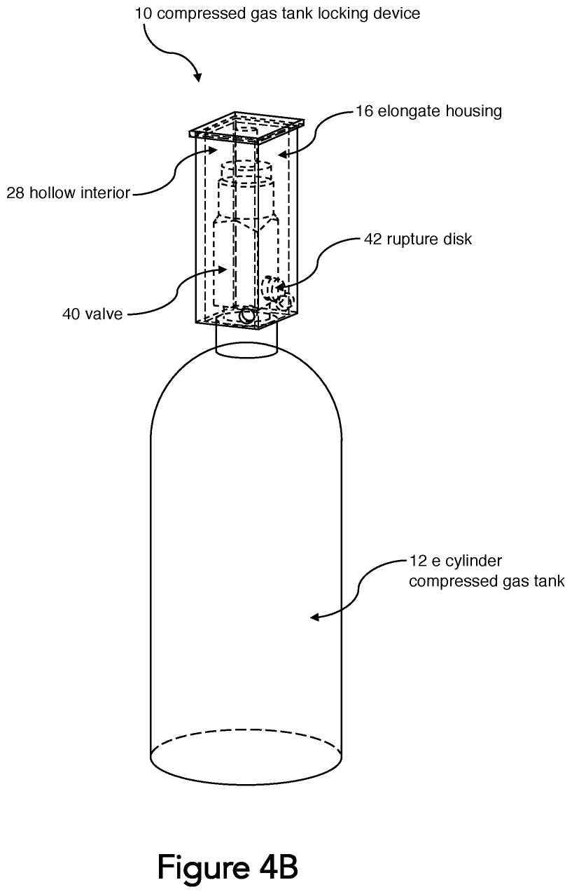

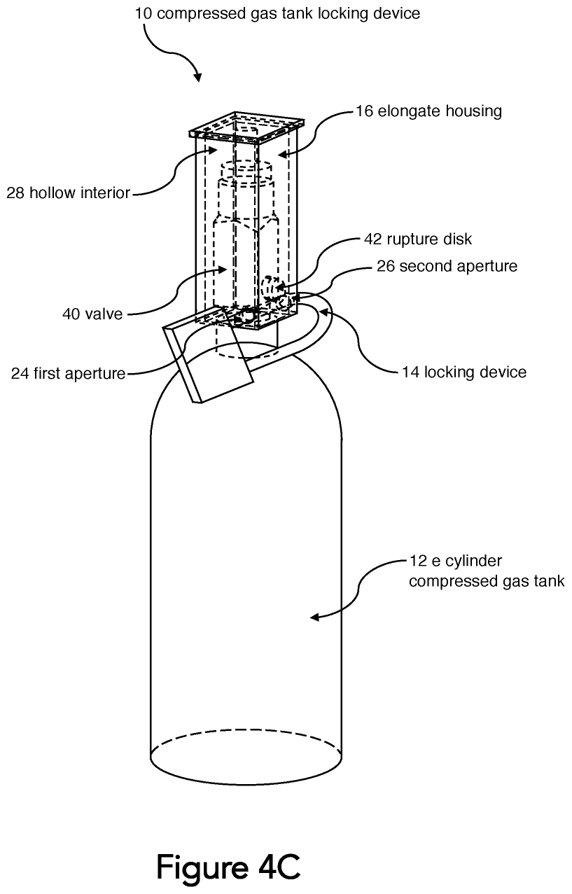

In some embodiments, the elongate housing 16 defines a hollow interior 28. The elongate housing 16 may receive a valve of the e cylinder compressed gas tank 12 within the hollow interior 28. Furthermore, the elongate housing 16 may be sized and configured to slidably and snuggably engage a top portion of the e cylinder compressed gas tank 12. According to the embodiments illustrated in FIGS. 3 and 4C, the term “snuggably” should be interpreted to mean that when the device 10 engages the top portion of the compressed gas tank 12 the device 10 moves along the first direction 15 by no more than 0.367 inches (or 47/128 inches). Furthermore, in some embodiments, when the rupture disc 42 is removed from the top portion and when the device 10 engages the top portion of the compressed gas tank 12 (without the rupture disk 42) the device 10 moves along the second direction 17 by no more than 0.234 inches (or 15/64 inches). Even still, in some embodiments, when the rupture disc 42 is coupled to the top portion and when the device 10 engages the top portion of the compressed gas tank 12 (with the rupture disk 42 in place) the device 10 moves along the second direction 17 by no more than 0.016 inches (or 1/64 inches). It should be appreciated that the device 10 may be sized and configured to provide for any distance of space along the first and second directions 15, 17, such as 0 inches, 0.1 inches, 0.2 inches, 0.3 inches, 0.4 inches, 0.5 inches, and any dimension therebetween.

With reference to FIG. 3, the sidewall 22 may comprise a first sidewall 30, a second sidewall 32, a third sidewall 34, and a fourth sidewall 36. The second sidewall 32 may be located opposite the first sidewall 30. The third sidewall 34 may be located between the first sidewall 30 and the second sidewall 32. The fourth sidewall 36 may be located opposite the third sidewall 34.

In some embodiments, the first sidewall 30, second sidewall 32, third sidewall 34, and fourth sidewall 36 may define a thickness of about 0.125 inch. In this context, the term “about” shall be interpreted to mean 0.125 inch + or −0.03125 w inch. Additionally, the first, second, third, and fourth sidewalls 30, 32, 34, 36 may comprise aluminum. As discussed above, aluminum is a lightweight, strong metal. Aluminum may thus resist any effort made to tamper with the device 10 and the valve 40 housed therein. It should be appreciated that the sidewalls 30, 32, 34, 36 may comprise at least one of aluminum, steel, stainless steel, magnesium, titanium, carbon fiber, plastic, alloys, composite materials, any combination thereof, and the like.

In some embodiments, the sidewalls 30, 32, 34, 36 are formed such that the elongate housing 16 of the device 10 defines a rectangular shape. However, it should be appreciated that the elongate housing 16 of the device may define a variety of shapes, such as circular, triangular, pentagonal, hexagonal, and the like. The device 10 may be formed in any shape to optimize the stability and durability of the device 10, and to maximize the protection that the device 10 provides to the valve of the e cylinder compressed gas tank 12.

With added reference to FIG. 3, the device 10 may be arranged and configured to receive a locking device 14 such that the device 10 may securely engage the e cylinder compressed gas tank 12. The first aperture 24 and the second aperture 26 may be sized and configured to slidably receive the locking device 14. In some embodiments, the locking device 14 defines a padlock. The locking device 14 may include at least one of a combination lock, guarded lock, government lock, high security lock, laminated lock, lockout lock, single-post shackle lock, cable lock, chain lock, and the like. Furthermore, the first aperture 24 and the second aperture 26 may be arranged and configured such that when the first and second apertures 24, 26 receive the locking device 14, the elongate housing 16 may snuggably and securely engage the top portion of the e cylinder compressed gas tank 12.

In some embodiments, the locking device 14 may define a lock used in combination with a member, such as a cable, that may be received by the first aperture 24 and the second aperture 26. For example, the locking device 14 may comprise a looped steel security cable and a lock. The first aperture 24 and the second aperture 26 may receive the looped steel security cable, and the lock may be secured to the cable through the cable's loops. Such an embodiment may be utilized to lock multiple e cylinder compressed gas tanks 12 to one another and/or to lock at least one e cylinder compressed gas tank 12 to a structure, as a steel cable lock may be sufficiently long to secure multiple objects and structures. It should be appreciated that the device 10 may be used with any locking device 14, wherein the locking device 14 is sized such that the first aperture 24 and the second aperture 26 may receive the locking device 14.

For example, an assisted living facility for senior citizens may keep a number of oxygen tanks on site, as many senior citizens use oxygen tanks as breathing aids. Assisted living facilities are oftentimes understaffed and lack security. A person visiting a resident of the facility, or even posing as a visitor, may thus steal an oxygen tank with relative ease if said oxygen tank is not properly secured within the facility. Such a person is likely to steal the tank for the value of the aluminum from which the tank is constructed. However, more than just illegal, this act is extremely dangerous to any within the vicinity of a stolen tank due to the highly reactive nature of compressed oxygen and a probable lack of knowledge the thief has of how to properly handle compressed gas cylinders. The device 10 may allow the staff to easily secure oxygen tanks not only to the facility, but also to one another, increasing the difficulty of stealing an oxygen tank significantly. Additionally, the device 10 may alleviate liability the facility and staff may have for any incidents caused by an oxygen tank that has been stolen or tampered with by impeding the ability to steal or tamper with the oxygen tank.

FIGS. 4A-4C illustrate the compressed gas tank locking device 10 and the e cylinder compressed gas tank 12. As shown in FIG. 4A, the device 10 may be sized and configured to slidably receive a top portion of the e cylinder compressed gas tank 12, thus slidably engaging said top portion. By saying that the device 10 is “sized and configured” this shall be interpreted to mean that the device is specifically designed with appropriate dimensions to securely fit onto the top portion of the e cylinder, leaving about 0.367 inches of space for the device 10 to wiggle along the first direction 15 and about 0.016 inches along the second direction 17 (when the rupture disk 42 is coupled to the top portion). In some embodiments, “sized and configured” shall be interpreted to mean that the device is specifically designed with appropriate dimensions to securely fit onto the top portion of the e cylinder, leaving about 0 inches along the second direction 17 (when the rupture disk 42 is coupled to the top portion).

Furthermore, the top portion of the e cylinder compressed gas tank 12 may comprise a valve 40, and the valve 40 may include a rupture disk 42, which is a pressure-relief device that relieves overpressure in compressed gas cylinders and typically comprises a nut and bolt. The elongate housing 16 of the device 10 may be sized and configured to slidably receive the valve 40 and the rupture disk 42 within the hollow interior 28 through the open end 20.

As illustrated in FIG. 4B, the elongate housing 16 may be sized and configured to snuggably engage the top portion of the e cylinder compressed gas tank 12. As such, the hollow interior 28 may be sized and configured to snuggably, closely and tightly fit around the valve 40. When the device 10 slidably receives the valve 40, the elongate housing 16 may thus engage the top portion of the e cylinder compressed gas tank 12 in a friction-fit-like manner. The snug fitting manner of the elongate housing 16 may ensure that the device 10 is secured to the top portion of the e cylinder compressed gas tank 12.

FIG. 4C shows the device 10 snuggably and securely engaged with the top portion of the e cylinder compressed gas tank 12. In some embodiments, the first aperture 24 and the second aperture 26 may be positioned on the sidewall 22 such that the first and second apertures 24, 26 are located vertically below the rupture disk 42 when the device 10 slidably and snuggably engages the top portion of the e cylinder compressed gas tank 12. Additionally, the device 10 may slidably engage the top portion of the e cylinder compressed gas tank 12 such that the first and second apertures 24 and 26 are located laterally relative to the rupture disk 42.

In several embodiments, when the first and second apertures 24 and 26 receive the locking device 14, the locking device 14 may be positioned under the rupture disk 42. The rupture disks of compressed gas tanks typically comprise a nut and bolt secured to the valve 40. As such, when the elongate housing 16 receives the valve 40 within the hollow interior portion 28 and the first and second apertures 24, 26 receive the locking device 14, the locking device may be positioned below the rupture disk 42. When the locking device 14 is put in a locked position, the rupture disk 42 thus prevents vertical movement of the device 10. The device 10 may thereby be securely and snuggably engaged with the e cylinder compressed gas tank 12.

A number of hospitals possess compressed gas cylinders for a variety of purposes, such as oxygen tanks for assisted breathing and anesthesia stored in compressed gas cylinders for surgery. Hospitals are busy, high-paced environments where life and death are often on the line. As such, compressed gas cylinders in hospitals cannot be under constant supervision by hospital personnel. Non-hospital personnel, such as patients and visitors, may gain access to at least one of the hospital's compressed gas cylinders, whether the cylinder or cylinders are in a patient's room or in storage. Someone such as a child, criminal, or mentally ill patient may tamper with the cylinders' valves and cause a disaster. The hospital is liable for any negative outcomes of such tampering, such as fires, explosions, and toxicity resulting from exposure to the pressurized gases. The manner in which the device 10 securely locks to gas cylinders may ensure that such incidents do not occur. This secure engagement of the device 10 with the gas cylinder significantly reduces not only the dangers of tampering with gas cylinders, but also a hospital's liability as the risk of such dangers decrease.

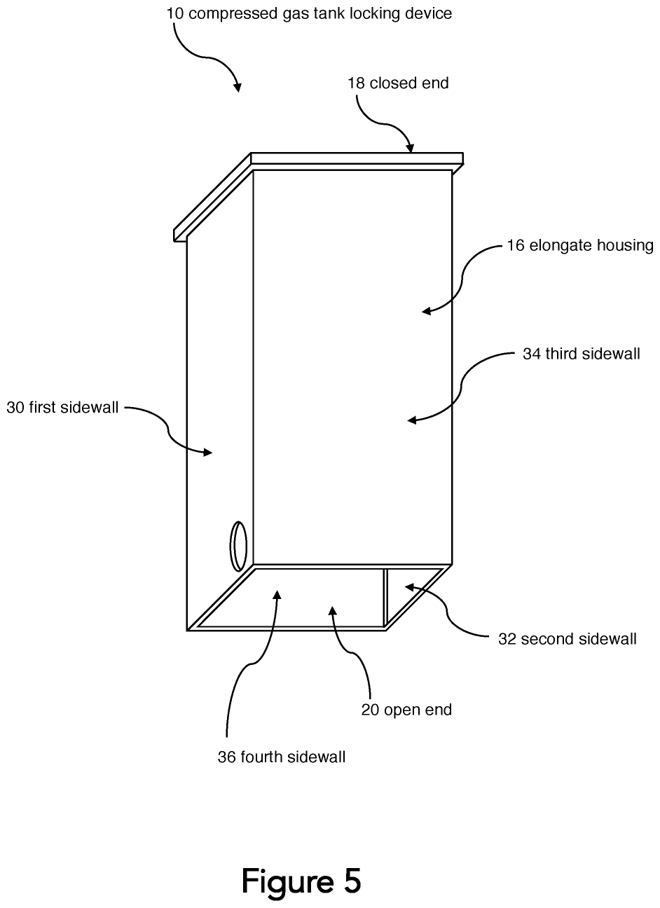

As illustrated in FIG. 5, the device 10 may comprise the closed end 18 and the open end 20. The closed end 18 and the open end 20 may each define a rectangular shape wherein the elongate housing 16 comprises the first sidewall 30, second sidewall 32, third sidewall 34, and fourth sidewall 36. In some embodiments, the closed end 18 and the open end 20 each define the shape of the elongate housing 16, such as circular, triangular, rectangular, pentagonal, hexagonal, and the like. It should be appreciated that the closed end 18 may define a shape differing from a shape of the open end 20.

In some embodiments, the closed end 18 and the open end 20 may not define the shape of the elongate housing 16. The open end 20 may be sized and shaped to receive the valve 40. The closed end 18 may be sized and shaped in a variety of manners that may optimize and/or maximize stability of the device 10 and the protection that the device 10 provides to the e cylinder compressed gas tank 12.

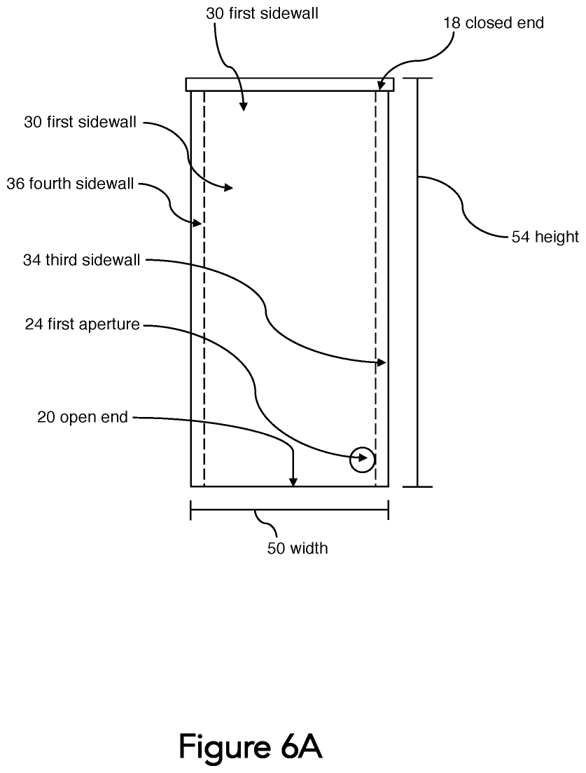

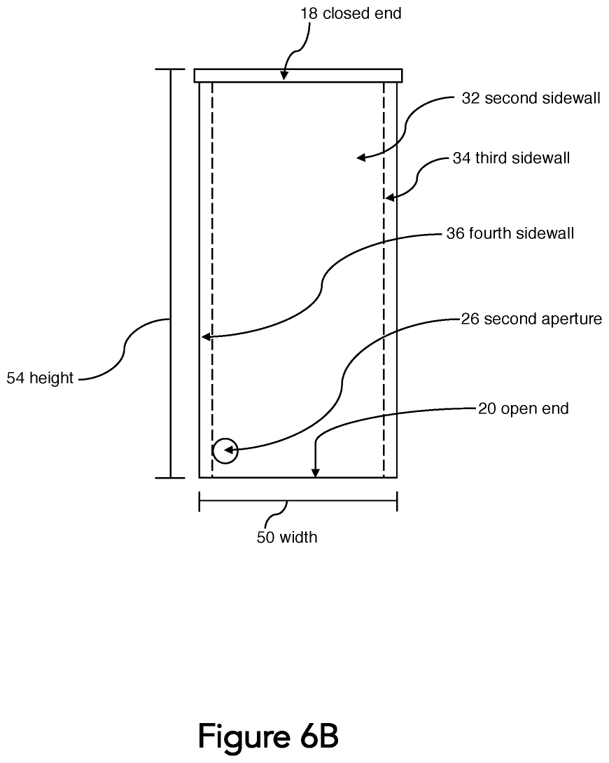

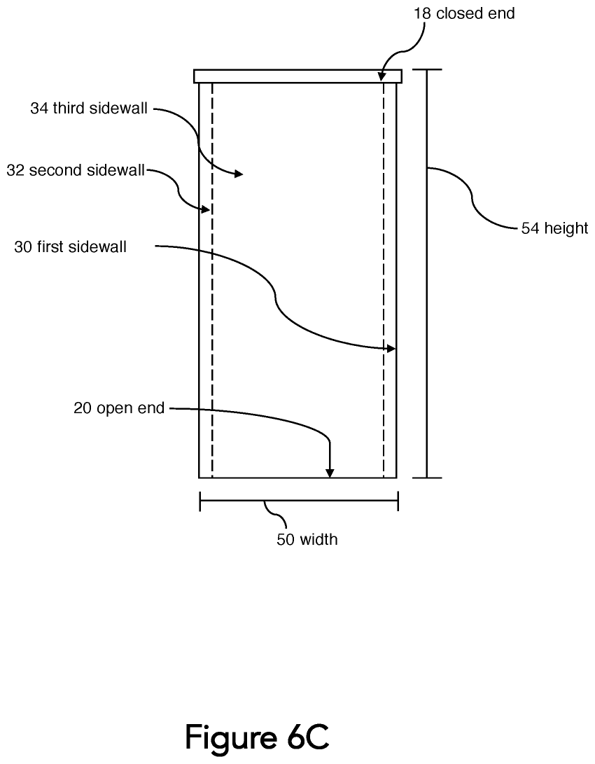

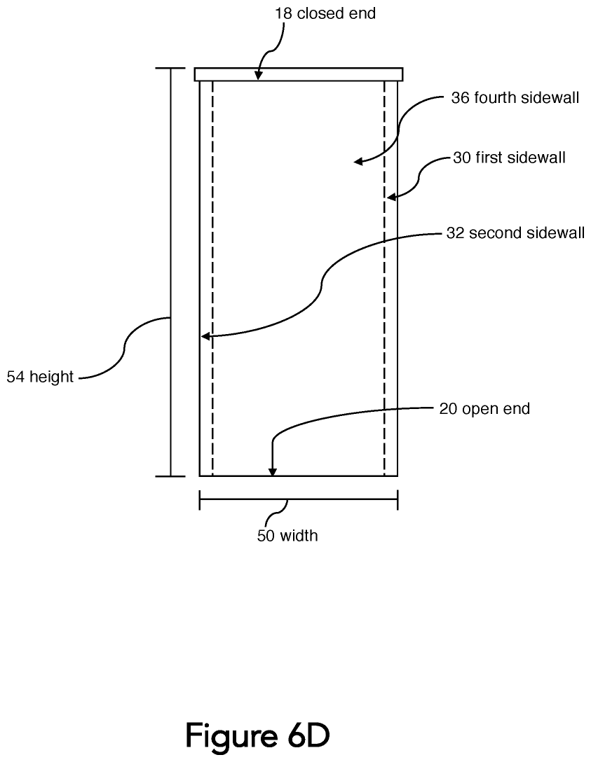

Referring now to FIG. 6A, the first aperture 24 may extend through the first sidewall 30 of the elongate housing 16. The first aperture 24 may be located closer to the open end 20 than the closed end 18. In some embodiments, the first aperture 24 is located about 0.125 inches from the open end 20. As well, the first aperture 24 may be located closer to the third sidewall 34 than the fourth sidewall 36. In some embodiments, the first aperture 24 is located about 0.125 inches from the third sidewall 34. In several embodiments, the first aperture 24 may define a diameter of about 0.25 inches.

As shown in FIG. 6B, the second aperture 26 may extend through the second sidewall 32 of the elongate housing 16. The second aperture 26 may be located closer to the open end 20 than the closed end 18. In some embodiments, the second aperture 26 is located about 0.125 inches from the open end 20. Further, the second aperture 26 may be located closer to the third sidewall 34 than the fourth sidewall 36. In several embodiments, the second aperture is located within 0.125 inches from the third sidewall 34. In some embodiments, the second aperture 26 may define a diameter of about 0.25 inches. Furthermore, the elongate housing 16 may be sized and configured such that the first aperture 24 and the second aperture 26 may be located on a same plane of the elongate housing 16, such that the first and second apertures 24, 26 may be located parallelly to each other on the first sidewall 30 and the second sidewall 32, respectively. Such a configuration may allow the locking device 14 to be received by the first and second apertures 24, 26, wherein at least the portion of the locking device received by the first and second apertures 24, 26 may be rigid.

With reference to FIGS. 6A-6D, the first sidewall 30, second sidewall 32, third sidewall 34, and fourth sidewall 36 may each define a height 54 that is less than or equal to about 4 inches and a width 50 that is less than or equal to about 2 inches. In several embodiments, the first sidewall 30, second sidewall 32, third sidewall 34, and fourth sidewall 36 may each define a height equal to about 3.5 inches and a width equal to about 1.5 inches.

It should be appreciated that the elongate housing 16 may be sized and configured such that the width 50 and height 54 define dimensions sized to completely cover the valve 40 of the e cylinder compressed gas tank 12. Furthermore, the dimensions of the elongate housing 16 may be sized such that the first aperture 24 and the second aperture 26 may be located vertically below the rupture disk 42 of the valve 40 when the device 10 slidably engages the top portion of the e cylinder compressed gas tank 12.

In several embodiments, when the first and second apertures 24, 26 receive the locking device 14, the locking device 14 may enable the device 10 to snuggably engage the top portion of the e cylinder compressed gas tank 12 such that the device 10 may not be removed until the locking device 14 is moved to an unlocked position and withdrawn from the first and second apertures 24, 26.

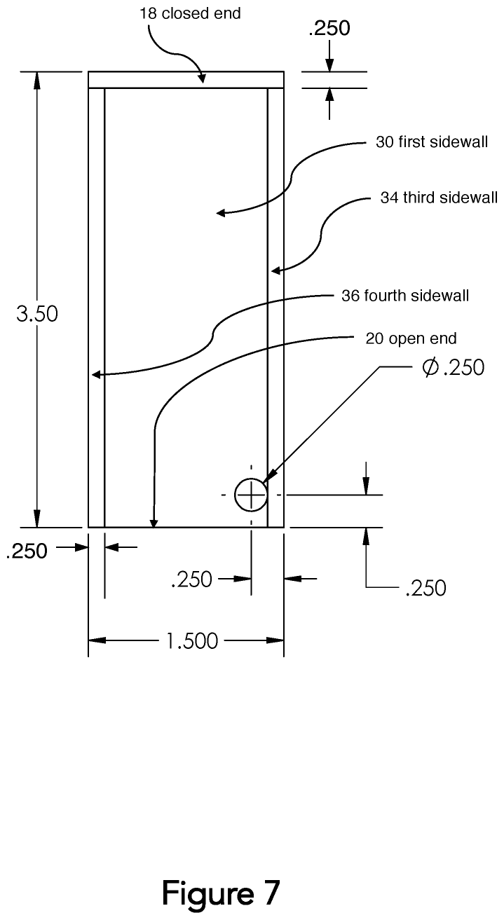

The embodiment shown in FIG. 7 illustrates a specific embodiment of device 10 sized and configured to couple with an e cylinder 12. As illustrated in FIG. 7, the device 10 is shown from the perspective of a straight on view of the first sidewall 30. It is important to note that in the embodiment of FIG. 7, the first, second, third, and fourth sidewalls 30, 32, 34, 36 have identical dimensions so the view of FIG. 7 applies to all sides. In this perspective, the device 10 defines a width of 1.5 inches, a height of 3.5 inches, and a sidewall thickness of 0.25 inches. These dimensions may be exactly as stated or about equal to the measurement stated. So in some embodiments, the width is 1.5 inches, while in other embodiments the width is about 1.5 inches, meaning that the width may vary by 0.1 inches. If dimensions are stated as “about” with reference to this embodiment, then it means that the dimension may vary by 0.1 inches as stated. So in some embodiments the height is 3.5 inches, while in other embodiments the height is about 3.5 inches, meaning that the height may vary between 3.4 inches and 3.6 inches.

Additionally, in some embodiments the sidewall thickness may be equal to 0.25 inches, while in some embodiments the sidewall thickness is equal to about 0.25 inches. In some embodiments, the topwall thickness is equal to 0.25 inches, yet in other embodiments the top thickness is equal to about 0.25 inches.

With regard to first and second aperture 24, 26 location along the respective sidewalls, the center of each respective aperture is 0.25 inches from the surface of the closest adjacent sidewall. In some embodiments, the center of each respective aperture is about 0.25 inches from the surface of the closest adjacent sidewall.

### INTERPRETATION

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may, “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A compressed gas tank locking device, including an elongate housing comprising:
a closed end;
an open end located opposite the closed end;
a sidewall extending between the closed end and the open end;
a first aperture extending through the sidewall; and
a second aperture extending through the sidewall, the second aperture located opposite the first aperture.

2. The device of claim 1, wherein the elongate housing is sized and configured to slidably and snuggably engage a top portion of an ecylinder compressed gas tank.

3. The device of claim 2, wherein the first aperture and the second aperture are sized and configured to slidably receive a locking device, and the first aperture and the second aperture are arranged and configured such that when the first aperture and the second aperture receive the locking device, the elongate housing is snuggably engaged with the top portion of the ecylinder compressed gas tank.

4. The device of claim 3, wherein the sidewall comprises a first sidewall, a second sidewall located opposite the first sidewall, a third sidewall located between the first sidewall and the second sidewall, and a fourth sidewall located opposite the third sidewall.

5. The device of claim 4, wherein the closed end and the open end each define a rectangular shape.

6. The device of claim 5, wherein the first aperture extends through the first sidewall, and the second aperture extends through the second sidewall.

7. The device of claim 6, wherein the first aperture is located closer to the open end than the closed end, and the second aperture is located closer to the open end than the closed end.

8. The device of claim 7, wherein the first aperture is located closer to the third sidewall than the fourth sidewall, and the second aperture is located closer to the third sidewall than the fourth sidewall.

9. The device of claim 8, wherein the first aperture is located about 0.125 inches from the open end, and the second aperture is located about 0.125 inches from the open end.

10. The device of claim 9, wherein the first aperture is located about 0.125 inches from the third sidewall, and the second aperture is located within 0.125 inches from the third sidewall.

11. The device of claim 8, wherein the first aperture and the second aperture each define a diameter of about 0.25 inches.

12. The device of claim 5, wherein the first sidewall, second sidewall, third sidewall, and fourth sidewall each define a height that is less than or equal to about 4 inches and a width that is less than or equal to about 2 inches.

13. The device of claim 12, wherein the first sidewall, second sidewall, third sidewall, and fourth sidewall each define a height equal to about 3.5 inches and a width equal to about 1.5 inches.
